(19) United States
(12) Patent Application Publication
(10) Pub. No.: US 2026/0142389 A1
(43) Pub. Date: May 21, 2026

(54) SHIELD TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Keisuke KANEMURA, Mie (JP); Hiroto TAKEUCHI, Mie (JP); Shohei TAKEGASA, Mie (JP)

(21) Appl. No.: 19/390,959

(22) Filed: Nov. 17, 2025

(30) Foreign Application Priority Data
Nov. 18, 2024 (JP) 2024-200188

(51) Int. Cl. H01R 9/05; H01R 11/28; H01R 13/02; H01R 13/504

(52) U.S. Cl. CPC H01R 9/0512; H01R 9/0518; H01R 11/28; H01R 13/025; H01R 13/504

(57) ABSTRACT

An outer conductor includes a first outer conductor and a second outer conductor that overlap each other via an overlapping portion. The overlapping portion includes welded portions that connects the first outer conductor and the second outer conductor. A rear-end portion of the dielectric is housed inside the overlapping portion. An outer peripheral surface of the rear-end portion of the dielectric includes recessed portions that is recessed away from the welded portions.

### CROSS-REFERENCE TO RELATED APPLICATIONS

This application is based on and claims priority from Japanese Patent Application No. 2024-200188, filed on Nov. 18, 2024, with the Japan Patent Office, the disclosure of which is incorporated herein in its entirety by reference.

### TECHNICAL FIELD

The present disclosure relates to a shield terminal.

### BACKGROUND

JP 2023-114581 A discloses a connector including an inner conductor, a dielectric that houses the inner conductor, and an outer conductor that houses the dielectric. The connector is connected to a terminal portion of a shielded electric wire, and is also referred to as a shield terminal (the term “shield terminal” is used in this specification). The outer conductor is composed of a first outer conductor and a second outer conductor. Both the first outer conductor and the second outer conductor are formed in a cylindrical shape with an axis oriented in the front-rear direction as a whole. A front-end portion of the first outer conductor is fitted into a rear-end portion of the second outer conductor. The front-end portion of the first outer conductor and the rear-end portion of the second outer conductor overlap each other in the radial direction to form an overlapping portion (not designated by such a name in JP 2023-114581 A). The overlapping portion is subjected to welding such as spot welding. By this welding, the first outer conductor and the second outer conductor are connected to each other.

### MARY

In the above-described case, the overlapping portion is relatively short in the front-rear direction, and the dielectric is located forward from the overlapping portion. If, for example, the overlapping portion is relatively long in the front-rear direction, it is desirable to also interpose the dielectric between the overlapping portion and a core wire located inside the overlapping portion for insulation and impedance matching between the overlapping portion and the core wire. However, in the case where the dielectric is interposed between the overlapping portion and the core wire, if the dielectric is in contact with the overlapping portion along its inner periphery, the heat of the welding performed on the overlapping portion may be directly transferred to the dielectric and damage the dielectric.

The present disclosure therefore has an object of providing a shield terminal capable of avoiding damage to a dielectric during welding.

A shield terminal according to the present disclosure is a shield terminal including an inner conductor, a dielectric, and an outer conductor, wherein the outer conductor includes a tubular first outer conductor with an axis oriented in an axial direction, and a tubular second outer conductor located coaxially with the first outer conductor, one axial end portion of the first outer conductor and another axial end portion of the second outer conductor overlap each other via an overlapping portion, the overlapping portion includes a welded portion that connects the first outer conductor and the second outer conductor, the inner conductor is housed inside the dielectric, the dielectric is housed inside the first outer conductor, another axial end portion of the dielectric is housed inside the overlapping portion, and an outer peripheral surface of the other axial end portion of the dielectric is provided with a recessed portion that is recessed away from the welded portion.

According to the present disclosure, it is possible to provide a shield terminal capable of avoiding damage to a dielectric during welding.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a shield terminal according to Embodiment 1 as seen obliquely from above and front.

FIG. 2 is a side sectional view of the shield terminal according to Embodiment 1.

FIG. 3 is a perspective view of a second outer conductor in the shield terminal according to Embodiment 1 as seen obliquely from above and rear.

FIG. 4 is a perspective view of a first outer conductor in the shield terminal according to Embodiment 1 as seen obliquely from above and front.

FIG. 5 is a perspective view of a dielectric in the shield terminal according to Embodiment 1 as seen obliquely from above and rear.

FIG. 6 is a perspective view of the dielectric in the shield terminal according to Embodiment 1 as seen obliquely from below and rear.

FIG. 7 is a rear view of the dielectric in the shield terminal according to Embodiment 1.

FIG. 8 is a partially broken away enlarged perspective view showing an overlapping portion and its surroundings at a connecting part between the first outer conductor and the second outer conductor in the shield terminal according to Embodiment 1.

FIG. 9 is a cross sectional view of the shield terminal according to Embodiment 1 taken at the positions of welded portions.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.

(1) A shield terminal according to the present disclosure is a shield terminal including an inner conductor, a dielectric, and an outer conductor, wherein the outer conductor includes a tubular first outer conductor with an axis oriented in an axial direction, and a tubular second outer conductor located coaxially with the first outer conductor, one axial end portion of the first outer conductor and another axial end portion of the second outer conductor overlap each other via an overlapping portion, the overlapping portion includes a welded portion that connects the first outer conductor and the second outer conductor, the inner conductor is housed inside the dielectric, the dielectric is housed inside the first outer conductor, another axial end portion of the dielectric is housed inside the overlapping portion, and an outer peripheral surface of the other axial end portion of the dielectric is provided with a recessed portion that is recessed away from the welded portion.

In a case where the other axial end portion of the dielectric is housed inside the overlapping portion, welding heat may be transferred to the dielectric during the formation of the welded portion and damage the dielectric. With the structure of (1), the outer peripheral surface of the other axial end portion of the dielectric is provided with the recessed portion that is recessed away from the welded portion. Therefore, welding heat is less likely to be transferred to the dielectric during the formation of the welded portion, and damage to the dielectric can be avoided.

(2) Preferably, in the shield terminal according to (1), the welded portion comprises a plurality of sets of welded portions in each of which the welded portions are arranged in vicinity of each other in a circumferential direction in the overlapping portion, and the recessed portion is provided in the dielectric for each of the plurality of sets of welded portions.

With the structure of (2), the number of recessed portions can be reduced as compared with the case where a recessed portion is provided individually for each welded portion, thereby avoiding complication of the structure of the dielectric and enabling accurate formation of each recessed portion. Moreover, because a larger space can be left within each recess, it is possible to more reliably avoid damaging the dielectric by heat generated during welding.

(3) Preferably, in the shield terminal according to (1) or (2), part of the outer peripheral surface of the other axial end portion of the dielectric excluding the recessed portion is located along an inner peripheral surface of the overlapping portion.

For example, in the case where the other axial end portion of the dielectric is located between a conductor such as a core wire of a shielded electric wire and the overlapping portion, insulation and impedance matching between the conductor and the overlapping portion can be obtained.

### Details of Embodiments of the Present Disclosure

Specific examples according to the present disclosure will be described below with reference to the drawings. The present disclosure is not limited to these examples, but is defined by the claims and intended to include all modifications within the meaning and scope equivalent to the claims.

### EMBODIMENT 1

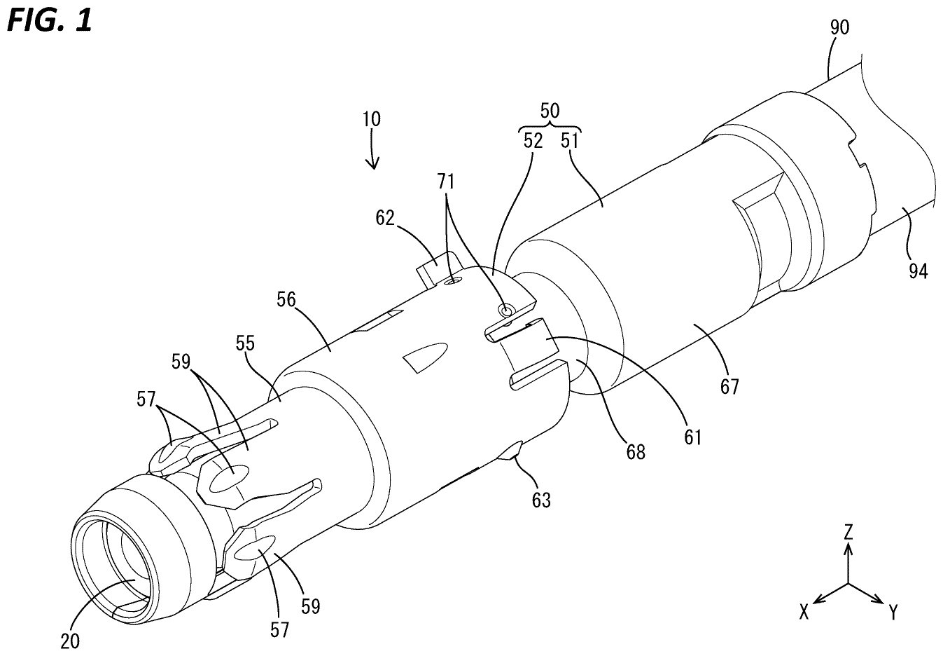

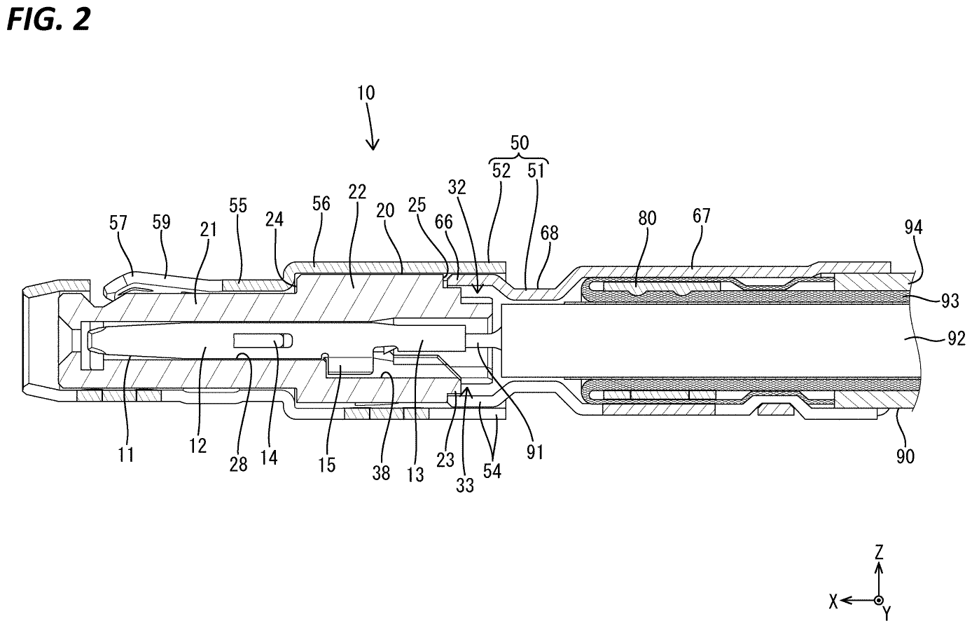

As shown in FIG. 1, a shield terminal 10 according to Embodiment 1 is connected to a terminal portion of a shielded electric wire 90. As shown in FIG. 2, the shield terminal 10 includes an inner conductor 11, a dielectric 20 that houses the inner conductor 11, and an outer conductor 50 that houses the dielectric 20. The shield terminal 10 has a shape elongated in the axial direction as a whole. In Embodiment 1, the axial direction corresponds to the front-rear direction. One axial end portion of the shielded electric wire 90 is the terminal portion of the shielded electric wire 90, and corresponds to a front-end portion of the shielded electric wire 90. In FIGS. 1 and 2, reference signs X, Y, and Z denote forward, rightward, and upward directions, respectively. The directional references are merely for convenience and, for example, “downward” is not limited to the direction of gravity.

### Inner Conductor

The inner conductor 11 is formed by, for example, bending a plate material made of conductive metal. As shown in FIG. 2, the inner conductor 11 includes a tubular connection portion 12 and a crimping portion 13 continuous with the rear of the connection portion 12. The connection portion 12 is connected to a mating inner conductor (not shown). The crimping portion 13 is connected by crimping to a conductor 91 such as a core wire in the terminal portion of the shielded electric wire 90. The shielded electric wire 90 is a coaxial cable, and includes an insulating coating 92 that surrounds the outer periphery of the conductor 91, a braided wire 93 in a mesh tube form that surrounds the outer periphery of the coating 92, and an insulating sheath 94 that surrounds the outer periphery of the braided wire 93. The conductor 91 has a function of transmitting high-frequency signals. The braided wire 93 has a function of shielding electromagnetic waves.

### Outer Conductor

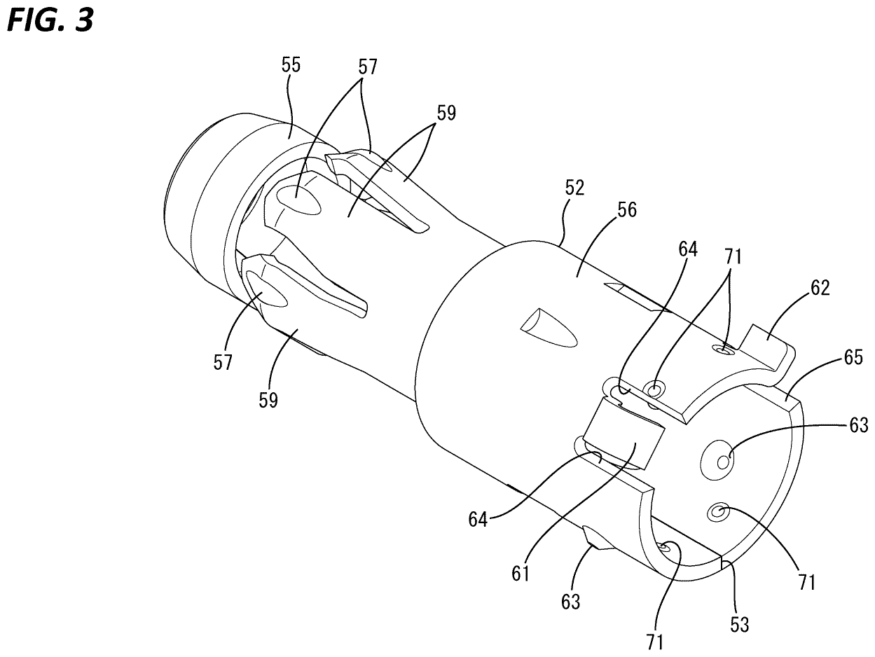

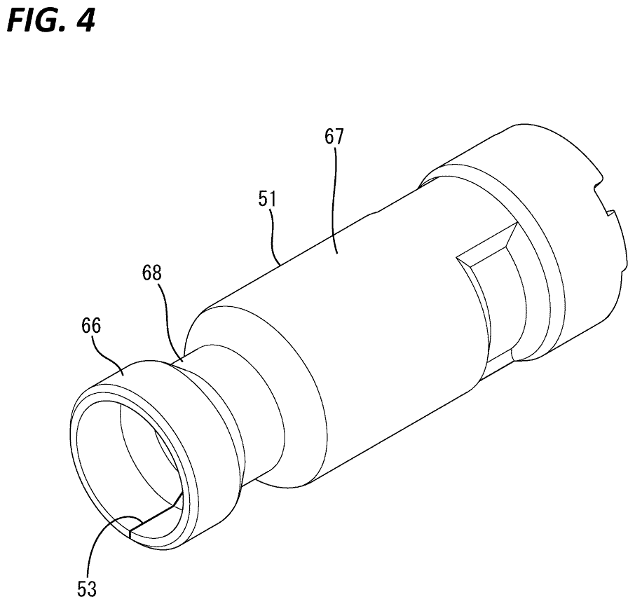

The outer conductor 50 is formed by, for example, bending a plate material made of conductive metal. The outer conductor 50 is composed of a first outer conductor 51 and a second outer conductor 52 that are separate bodies. As shown in FIGS. 3 and 4, both the first outer conductor 51 and the second outer conductor 52 are formed in a cylindrical shape with an axis oriented in the front-rear direction. The lowermost end of each of the first outer conductor 51 and the second outer conductor 52 has mating edges 53 facing each other so as to be abuttable at both circumferential ends.

As shown in FIG. 2, the second outer conductor 52 is located forward from the first outer conductor 51 via an overlapping portion 54 (described later). The second outer conductor 52 surrounds the outer periphery of the dielectric 20. As shown in FIG. 3, the second outer conductor 52 includes a small-diameter portion 55 at the front and a large-diameter portion 56 at the rear. The large-diameter portion 56 is larger in diameter than the small-diameter portion 55. The small-diameter portion 55 is provided with a plurality of contact portions 57. The contact portions 57 are arranged side by side in the circumferential direction in the small-diameter portion 55. Among the contact portions 57, some (four contact portions) are displaceably provided in elastically deformable spring portions 59, and the others (two contact portions (not shown)) are fixed to the small-diameter portion 55. A mating outer conductor (not shown) is fitted to the small-diameter portion 55. Each contact portion 57 conductively contacts the mating outer conductor from the radially inner side.

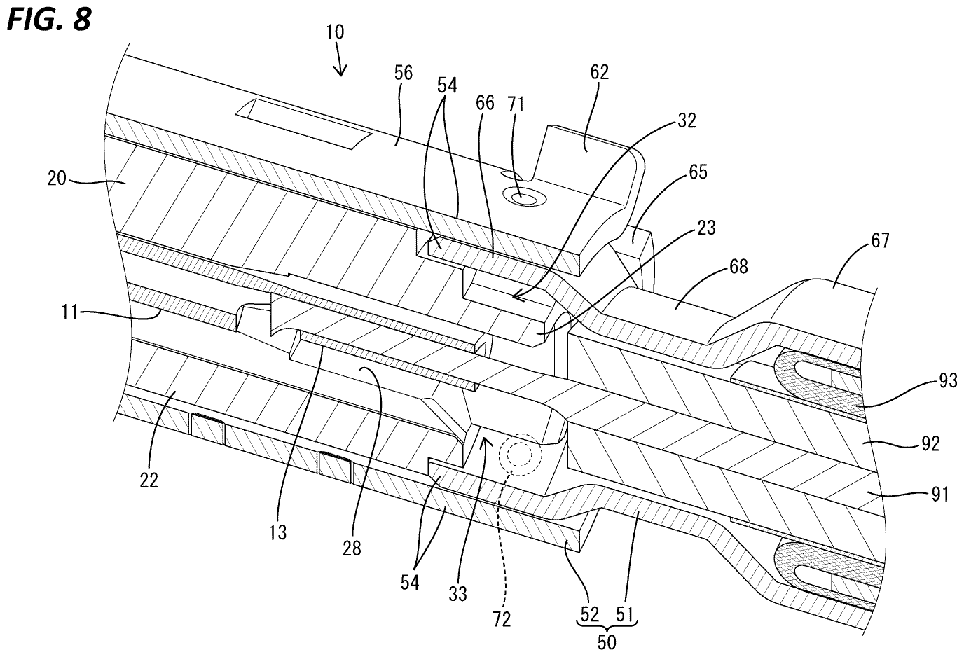

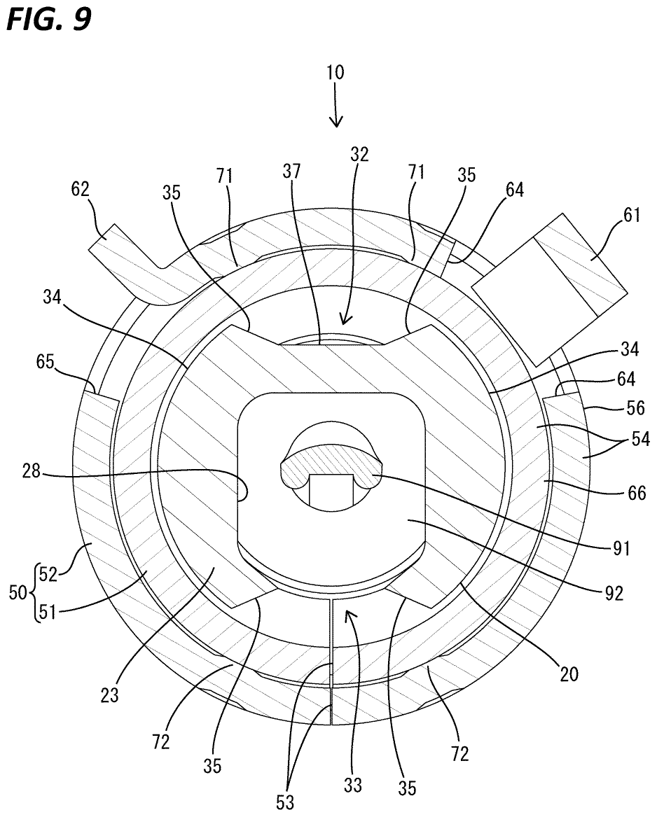

The large-diameter portion 56 includes one erroneous insertion prevention portion 61, one rotation suppression portion 62, and a pair of rattling preventing portions 63. The erroneous insertion prevention portion 61 is located at a rear-end portion of the large-diameter portion 56. As shown in FIGS. 8 and 9, the rear-end portion of the large-diameter portion 56 forms the overlapping portion 54 of the second outer conductor 52.

As shown in FIG. 9, the erroneous insertion prevention portion 61 is located at a position rightward-downward from the uppermost end of the large-diameter portion 56. As shown in FIG. 3, the erroneous insertion prevention portion 61 is provided between a pair of slits 64 circumferentially arranged in the large-diameter portion 56, and is shaped so as to bend radially outward like a mountain. The front surface of the erroneous insertion prevention portion 61 faced obliquely forward. The front surface of the erroneous insertion prevention portion 61 is a plate surface of the large-diameter portion 56 and is formed smoothly. When the shield terminal 10 is inserted into a housing of a connector (not shown), if the insertion posture of the shield terminal 10 is improper in the circumferential direction, the front surface of the erroneous insertion prevention portion 61 abuts against the opposing surface of the housing. This prevents the shield terminal 10 in an improper posture from being inserted into the housing. Particularly in Embodiment 1, the front surface of the erroneous insertion prevention portion 61 is a smooth surface, which is advantageous in that damage to the opposing surface of the housing can be prevented.

As shown in FIG. 9, the rotation suppression portion 62 is located at a position leftward-downward from the uppermost end of the large-diameter portion 56. As shown in FIG. 3, the rotation suppression portion 62 is formed by bending part of the large-diameter portion 56 along a fold line in the front-rear direction so as to project radially outward. The rotation suppression portion 62 has a flat plate shape, with its plate surface facing the circumferential direction. An opening 65 is formed in part of the large-diameter portion 56 as a result of bending up the rotation suppression portion 62. The rotation suppression portion 62 is inserted into a rotation suppression groove of a housing (not shown). As a result of the plate surface of the rotation suppression portion 62 coming into contact with the groove surface of the rotation suppression groove, rotation of the shield terminal 10 about its axis within the housing is suppressed.

As shown in FIG. 3, the pair of rattling preventing portions 63 are located at a lower end portion of the large-diameter portion 56 and below each of the erroneous insertion prevention portion 61 and the rotation suppression portion 62. Each rattling preventing portion 63 is formed to bulge radially outward in an embossed shape in the large-diameter portion 56. As a result of each rattling preventing portion 63 coming into contact with the inner peripheral surface of the housing, play (backlash) of the shield terminal 10 within the housing is suppressed.

As shown in FIG. 4, the first outer conductor 51 includes a tubular connection portion 66, a tubular body portion 67 located rearward from the tubular connection portion 66, and a constricted portion 68 located between the tubular body portion 67 and the tubular connection portion 66 in the front-rear direction. The constricted portion 68 has a constricted shape reduced radially inward from the rear-end of the tubular connection portion 66 and the front end of the tubular body portion 67. A lance of a housing (not shown) is inserted into and positioned in the constricted portion 68. As shown in FIGS. 2 and 8, the tubular body portion 67 is connected by crimping to the braided wire 93 of the shielded electric wire 90. As shown in FIGS. 8 and 9, the tubular connection portion 66 is coaxially fitted into the rear-end portion of the large-diameter portion 56 to form the overlapping portion 54 of the first outer conductor 51.

The overlapping portion 54 is a part where the first outer conductor 51 and the second outer conductor 52 overlap each other in the radial direction (facing part), and is formed by the rear-end portion of the large-diameter portion 56 and the tubular connection portion 66 as mentioned above. The rear-end portion of the large-diameter portion 56 and the tubular connection portion 66 are conductively fixed by a plurality of welded portions 71 and 72 arranged at intervals in the circumferential direction. As shown in FIG. 8, the welded portions 71 and 72 have a circular embossed shape and serve to fix the overlapping portion 54 by thermal welding means such as spot welding. In Embodiment 1, a total of four welded portions 71 and 72 are provided as shown in FIG. 3. Among the four welded portions 71 and 72, two welded portions 71 are arranged between the erroneous insertion prevention portion 61 and the rotation suppression portion 62 in the circumferential direction. Specifically, the two welded portions 71 are arranged at a position near the uppermost end and adjacent to the slit 64 and at a position near the uppermost end and adjacent to the rotation suppression portion 62. With this configuration, a plate piece portion between the opening 65 and the slit 64 is effectively fixed by each welded portion 71, and both the erroneous insertion prevention portion 61 and the rotation suppression portion 62 can be maintained in a state of projecting at fixed positions. Among the four welded portions 71 and 72, the remaining two welded portions 72 are arranged between the pair of rattling preventing portions 63 in the circumferential direction and close to and rearward from the rattling preventing portions 63, as shown in FIG. 3. The two welded portions 72 are arranged on both sides of the mating edges 53 in the circumferential direction.

### Dielectric

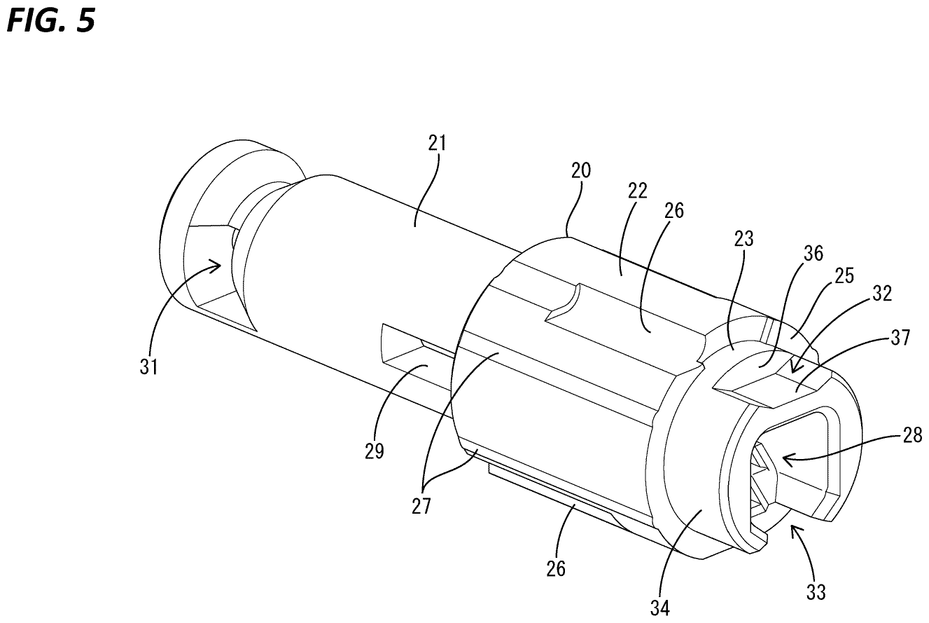

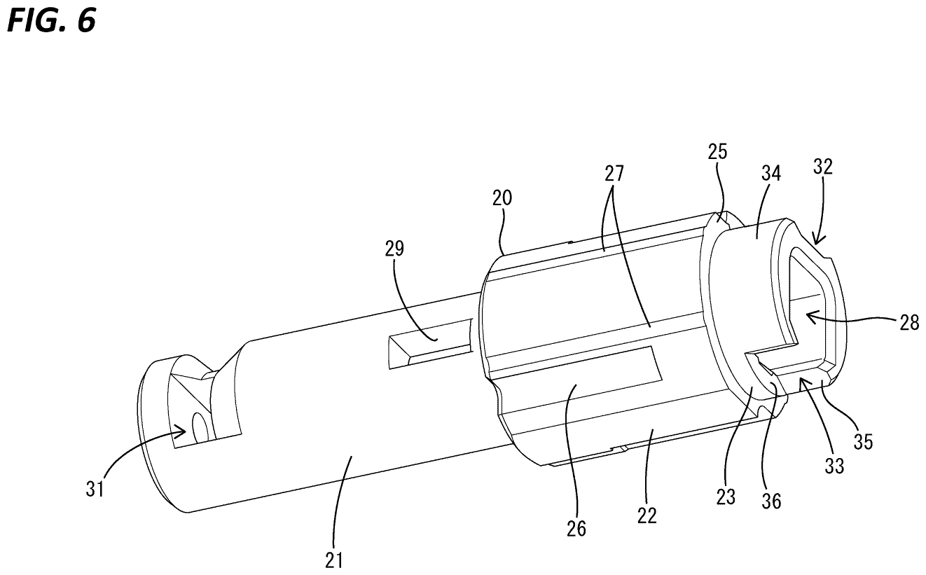

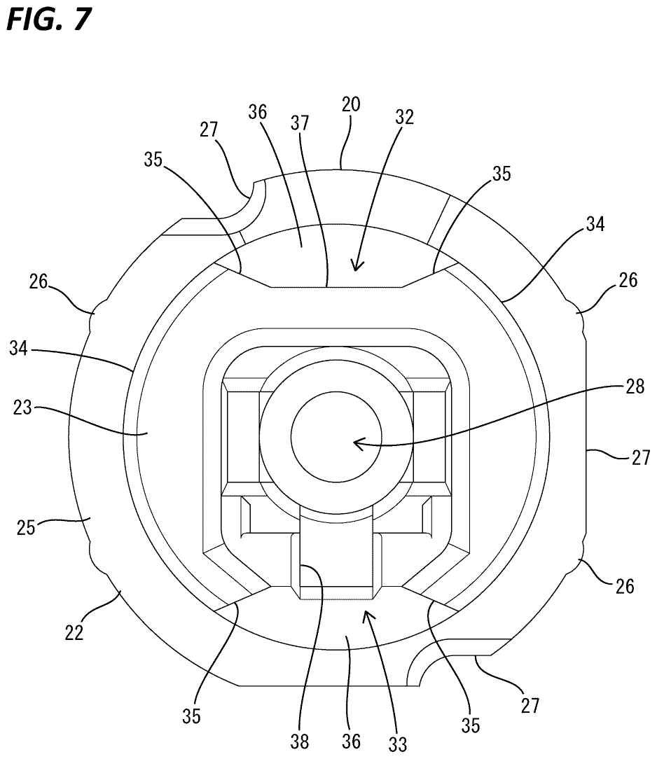

The dielectric 20 is made of synthetic resin and has a cylindrical shape, and extends in the front-rear direction within the range contained inside the second outer conductor 52 as shown in FIG. 2. As shown in FIGS. 5 and 6, the dielectric 20 is formed by sequentially connecting a front portion 21, an intermediate portion 22, and a rear portion 23 from the front side to the rear side. The intermediate portion 22 is larger in diameter than the front portion 21 and the rear portion 23. As shown in FIG. 2, the front surface of the intermediate portion 22 is a forward-facing front step portion 24 in the radial direction. The lower end of the front step portion 24 intersects (orthogonally) the rear-end of the front portion 21. The front step portion 24 faces a stepped part between the small-diameter portion 55 and the large-diameter portion 56 of the second outer conductor 52 so as to be contactable with the stepped part. As shown in FIGS. 5 and 7, the rear surface of the intermediate portion 22 is a rearward-facing rear step portion 25 in the radial direction. The lower end of the rear step portion 25 intersects (orthogonally) the front end of the rear portion 23. The rear step portion 25 faces the front end of the tubular connection portion 66 of the first outer conductor 51 so as to be abuttable against the front end of the tubular connection portion 66. Forward displacement of the first outer conductor 51 is prevented by the rear step portion 25.

As shown in FIGS. 5 and 6, the front-rear length of the front portion 21 is longer than the front-rear length of the intermediate portion 22, and the front-rear length of the intermediate portion 22 is longer than the front-rear length of the rear portion 23. The outer peripheral surface of the front portion 21 is circular in cross section. The outer peripheral surface of the rear portion 23 is circular in cross section with recessed portions 32 and 33 (described later) formed in its peripheral surface portion. The outer peripheral surface of the intermediate portion 22 is circular in cross section with a plurality of cutout portions 26 and ribs 27 formed in its peripheral surface portion.

As shown in FIG. 2, the dielectric 20 has a receiving hole 28 extending in the front-rear direction and penetrating through the front portion 21, the intermediate portion 22, and the rear portion 23 over the entire length. The front end of the receiving hole 28 opens circularly on the front surface of the front portion 21 (see FIG. 7). The rear-end of the receiving hole 28 opens rectangularly (non-circularly) with four rounded corners on the rear surface of the rear portion 23. The inner conductor 11 is inserted into the receiving hole 28 from the rear.

As shown in FIGS. 5 and 6, the front portion 21 has a locking hole 29 penetrating radially from the receiving hole 28 to the outer peripheral surface of the front portion 21. In a state where the inner conductor 11 is inserted into the receiving hole 28, an elastic locking portion 14 (see FIG. 2) formed in the connection portion 12 is hooked and locked in the locking hole 29. This prevents the inner conductor 11 from coming out of the dielectric 20. An observation hole 31 is formed at the front-end portion of the front portion 21, through which the front end of the inner conductor 11 inserted into the receiving hole 28 can be observed.

As shown in FIGS. 5 to 7, the recessed portions 32 and 33 are arranged as a pair at the upper and lower end portions of the outer peripheral surface of the rear portion 23 respectively. At parts of the outer peripheral surface of the rear portion 23 between the recessed portions 32 and 33, curved surfaces 34 having a circular arc cross section are arranged as a pair in the left-right direction. The outer peripheral surface of the rear portion 23 except for the front-end portion is composed of the pair of upper and lower recessed portions 32 and 33 and the pair of left and right curved surfaces 34 arranged in the circumferential direction.

Among the recessed portions 32 and 33, the upper recessed portion 32 is formed as a shallow-bottomed recess at the upper end portion of the outer peripheral surface of the rear portion 23. As shown in FIG. 7, the upper recessed portion 32 is defined by a pair of inner side surfaces 35 facing each other in the left-right direction, an inner end surface 36 facing rearward at the front end (see FIG. 5), and an inner bottom surface 37 facing upward between the inner side surfaces 35. The upper recessed portion 32 is open to the rear of the rear portion 23. The inner bottom surface 37 has a rectangular outer shape as seen from above, and is arranged flat in the front-rear direction and the left-right direction. The inner end surface 36 intersects (orthogonally) the front-end of the inner bottom surface 37, and is arranged vertically in the up-down direction and the left-right direction. The inner side surfaces 35 extend upward from the left and right ends of the inner bottom surface 37 while being inclined so that the space therebetween will widen outward in the left-right direction. The front-ends of the inner side surfaces 35 intersect (orthogonally) the left and right ends of the inner end surface 36 respectively.

As shown in FIG. 6, among the recessed portions 32 and 33, the lower recessed portion 33 is formed as a bottomless (open-bottom) recess at the lower end of the outer peripheral surface of the rear portion 23 so as to communicate with the receiving hole 28. The lower recessed portion 33 has the same structure as the upper recessed portion 32 except that it does not have the inner bottom surface 37. In detail, as shown in FIG. 7, the lower recessed portion 33 is defined by an inner end surface 36 facing rearward at the front end and a pair of inner side surfaces 35 extending downward from the left and right ends with the space therebetween widening outward in the left-right direction, and is open to the rear of the rear portion 23. As shown in FIG. 7, the rear-end of a guide groove 38 opens on the inner end surface 36 of the lower recessed portion 33. As shown in FIG. 2, the guide groove 38 extends in the front-rear direction from the rear portion 23 to the intermediate portion 22, and receives a stabilizer 15 of the inner conductor 11. The stabilizer 15 serves to prevent erroneous insertion of the inner conductor 11 into the receiving hole 28 and to guide the insertion. The inner end surfaces 36 of the pair of upper and lower recessed portions 32 and 33 are arranged at the same position in the front-rear direction.

### Operation of Shield Terminal

During assembly of the shield terminal 10, first, the inner conductor 11 is inserted into and housed in the receiving hole 28 of the dielectric 20. The inner conductor 11 is connected by crimping to the conductor 91 of the shielded electric wire 90 in advance. By the inner conductor 11 being housed in the receiving hole 28 of the dielectric 20, the crimping portion 13 is positioned extending from the intermediate portion 22 to the front-end portion of the rear portion 23 (see FIG. 2). An exposed part of the conductor 91 of the shielded electric wire 90, which is located between the coating 92 and the crimping portion 13, is positioned inside the rear portion 23. The stabilizer 15 of the inner conductor 11 is inserted into the guide groove 38.

Subsequently, the front-end portion of the first outer conductor 51 is fitted into the rear end portion of the second outer conductor 52. As a result, the inner peripheral surface of the large-diameter portion 56 and the outer peripheral surface of the tubular connection portion 66 face and overlap each other to form the overlapping portion 54. In this state, welding such as spot welding is performed on the corresponding positions at the upper and lower end portions of the outer peripheral surface of the large-diameter portion 56 (i.e. the formation positions of the above-described welded portions 71 and 72), thus forming the welded portions 71 and 72. As a result of the overlapping portion 54 being fixed by the welded portions 71 and 72, the first outer conductor 51 and the second outer conductor 52 are held in a connected state. As shown in FIG. 2, the braided wire 93 of the shielded electric wire 90 is disposed inside the first outer conductor 51 and is crimped to the tubular body portion 67 via the sleeve 80. This completes the assembly of the shield terminal 10.

As shown in FIGS. 2 and 9, the rear portion 23 of the dielectric 20 is housed inside the overlapping portion 54. The outer peripheral surface of the front-end portion of the rear portion 23 and the curved surfaces 34 are arranged along the inner peripheral surface of the tubular connection portion 66 in the overlapping portion 54 so as to contactably face the inner peripheral surface of the tubular connection portion 66. Meanwhile, as shown in FIG. 9, the upper recessed portion 32 is positioned away from the inner peripheral surface of the tubular connection portion 66 in the upper overlapping portion 54, thereby avoiding contact with the two welded portions 71 formed on the upper side of the overlapping portion 54. Specifically, the welded portion 71 adjacent to the slit 64 is located above the right inner side surface 35 of the recessed portion 32 in the drawing, and the inner peripheral surface of the tubular connection portion 66 in the overlapping portion 54 at the corresponding position is separated from the right inner side surface 35 in the drawing. The welded portion 71 adjacent to the rotation suppression portion 62 is located above the left inner side surface 35 of the recessed portion 32 in the drawing, and the inner peripheral surface of the tubular connection portion 66 in the overlapping portion 54 at the corresponding position is separated from the left inner side surface 35 in the drawing.

Similarly, the lower recessed portion 33 avoids contact with the two welded portions 72 formed on the lower side of the overlapping portion 54. Specifically, each lower welded portion 72 is located below the corresponding one of the left and right inner side surfaces 35 of the lower recessed portion 33, and the inner peripheral surface of the tubular connection portion 66 in the overlapping portion 54 at the corresponding position is separated from the inner side surface 35. Thus, the dielectric 20 avoids contact with the welded portions 71 and 72 of the overlapping portion 54 by means of the recessed portions 32 and 33. Accordingly, the heat generated during the formation of the welded portions 71 and 72 is released into the spaces of the recessed portions 32 and 33 and is not directly transferred to the rear portion 23 of the dielectric 20. As a result, deformation or burning of the dielectric 20 caused by heat can be avoided.

As described above, the shield terminal 10 according to Embodiment 1 includes an inner conductor 11, a dielectric 20, and an outer conductor 50. The outer conductor 50 includes a tubular first outer conductor 51 with an axis oriented in the front-rear direction (axial direction), and a tubular second outer conductor 52 located coaxially with the first outer conductor 51. A front-end portion (one axial end portion) of the first outer conductor 51 and a rear-end portion (another axial end portion) of the second outer conductor 52 overlap each other via an overlapping portion 54. The overlapping portion 54 includes a welded portions 71 and 72 that connect the first outer conductor 51 and the second outer conductor 52. The inner conductor 11 is housed inside the dielectric 20. The dielectric 20 is housed inside the first outer conductor 51. A rear-end portion (rear portion 23) of the dielectric 20 is housed inside the overlapping portion 54. An outer peripheral surface of the rear-end portion of the dielectric 20 is provided with recessed portions 32 and 33 that is recessed away from the welded portions 71 and 72. Because the recessed portions 32 and 33 provided at the rear-end portion of the dielectric 20 hinder transfer of welding heat to the dielectric 20 during the formation of the welded portions 71 and 72, damage such as deformation or burning of the dielectric 20 can be avoided.

Moreover, in Embodiment 1, the set of the welded portions 71 and 72 comprises a plurality of sets of welded portions (upper set and lower set in Embodiment 1) in each of which the welded portions are arranged in vicinity of each other in a circumferential direction in the overlapping portion 54. The recessed portions 32 and 33 are respectively provided in the dielectric 20 for the plurality of sets of welded portions 71 and 72. With this configuration, the number of recessed portions 32 and 33 can be reduced as compared with the case where a recessed portion is provided individually for each welded portion, thereby avoiding complication of the structure of the dielectric 20 and enabling accurate formation of each recessed portions 32 and 33. Moreover, because a larger space can be left within each of the recessed portions 32 and 33, it is possible to more reliably avoid damaging the dielectric 20 by heat generated during welding.

Further, in Embodiment 1, part (part including the curved surface 34) of the outer peripheral surface of the rear-end portion of the dielectric 20 excluding the recessed portions 32 and 33 is located along an inner peripheral surface of the overlapping portion 54. With this configuration, insulation and impedance matching between the conductor 91 and the overlapping portion 54 can be ensured by the rear-end portion of the dielectric 20.

### Other Embodiments of the Present Disclosure

The foregoing Embodiment 1 disclosed herein is illustrative and not restrictive in all respects.

In Embodiment 1, a recessed portion is provided in the dielectric for each of a plurality of sets of welded portions. In another embodiment, a recessed portion may also be provided in the dielectric for each welded portion individually. Alternatively, a recessed portion may also be provided in the dielectric for a plurality of sets of welded portions collectively.

In Embodiment 1, among the plurality of recessed portions, the upper recessed portion is formed as a bottomed recess and the lower recessed portion is formed as a bottomless recess. In another embodiment, all of the recessed portions may also be formed as a bottomed recess. Alternatively, all of the recessed portions may also be formed as a bottomless recess.

In Embodiment 1, the front-end portion of the first outer conductor is fitted into the rear-end portion of the second outer conductor to form the overlapping portion. In another embodiment, the rear-end portion of the second outer conductor may also be fitted into the front-end portion of the first outer conductor to form the overlapping portion.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shield terminal comprising an inner conductor, a dielectric, and an outer conductor,
wherein the outer conductor includes a tubular first outer conductor with an axis oriented in an axial direction, and a tubular second outer conductor located coaxially with the first outer conductor,
one axial end portion of the first outer conductor and another axial end portion of the second outer conductor overlap each other via an overlapping portion,
the overlapping portion includes a welded portion that connects the first outer conductor and the second outer conductor,
the inner conductor is housed inside the dielectric,
the dielectric is housed inside the first outer conductor,
another axial end portion of the dielectric is housed inside the overlapping portion, and
an outer peripheral surface of the other axial end portion of the dielectric is provided with a recessed portion that is recessed away from the welded portion.

2. The shield terminal according to claim 1, wherein the welded portion comprises a plurality of sets of welded portions in each of which the welded portions are arranged in vicinity of each other in a circumferential direction in the overlapping portion, and
the recessed portion is provided in the dielectric for each of the plurality of sets of welded portions.

3. The shield terminal according to claim 1, wherein part of the outer peripheral surface of the other axial end portion of the dielectric excluding the recessed portion is located along an inner peripheral surface of the overlapping portion.
